(19) United States
(12) Patent Application Publication
(10) Pub. No.: US 2013/0099643 A1
(43) Pub. Date: Apr. 25, 2013

(54) Double Hinge Assembly

(71) Applicants: Timothy Mark Kromrey, Milwaukee, WI (US); Laurence Geist, Dousman, WI (US)

(72) Inventors: Timothy Mark Kromrey, Milwaukee, WI (US); Laurence Geist, Dousman, WI (US)

(73) Assignee: Cooper Technologies Company, Houston, TX (US)

(21) Appl. No.: 13/276,621

(22) Filed: Oct. 19, 2011

(51) Int. Cl. A47B 96/00; E05D 5/10

(52) U.S. Cl. 312/326; 16/386

(57) ABSTRACT

A double hinge assembly is described including a center wing having a first center wing barrel portion and a second center wing barrel portion, a barrel pin, and a swing panel including a swing panel barrel portion, where the swing panel barrel portion and the second center wing barrel portion are adjoined by the barrel pin to form a first pivot about a first axis. Further aspects of the double hinge assembly include the first and second center wing barrel portions being formed respectively at two opposing edges of the center wing, the center wing including a tab at one end, and the tab projecting perpendicularly outward with respect to major sides of the center wing.

### BACKGROUND

From time to time, existing systems, components, and associated infrastructure must be updated. For example, after failure of a system or a component of a system, the system or component is generally replaced or updated with new systems or components. Alternatively, existing systems are often updated in accordance with improved features of new systems, such as higher efficiencies. In many cases, the cost of updating existing systems and components is high both in materials and time. Infrastructure associated with existing systems must be replaced in certain situations although the infrastructure is still suitable for its originally intended purpose, because new systems and components do not interface with or conform to physical requirements of the original infrastructure. Thus, updating existing systems and components may carry a significant cost, which is often passed along to consumers.

Ideally, the original infrastructure of existing systems should be reused as much as possible to reduce costs associated with updating the existing systems. For example, original cabinets and wiring conduits may be reused when replacing legacy systems or components with updated systems or components. When original infrastructure is reused, material costs are relatively reduced. Additionally, time is also saved because the original infrastructure is reused in place, without the necessity for removal and replacement of the original infrastructure. In other words, the amount of time required for engineers and field technicians to retrofit existing infrastructure with updated systems and components is generally less than the amount of time required to replace the existing infrastructure and also install the updated systems and components.

However, existing cabinets, wiring conduits, and other infrastructure may not be suitable for housing or enclosing updated systems. For example, existing cabinets were not designed to enclose updated systems and components and may be too large or small to reasonably accommodate them. To reuse existing cabinets, updated systems and components must fit within the existing cabinets, and there is a need for the updated systems to be easy to install and service when mounted within the existing cabinets. Further, it is desirable for field technicians to be able to simply and quickly install and service the updated systems and components even after they have been installed.

One challenge of updating existing systems and components within original cabinets and infrastructure is that several variations of the original cabinets and infrastructure may exist. In this case, updated systems and components may need to be designed to be used with existing cabinets and infrastructure designed and manufactured by several different manufacturers over various dates of manufacturing.

In this context, new hardware for installation of updated systems and controls within existing cabinet enclosures is desired. Ideally, the new hardware should be suitable for installation within a wide variety of existing control cabinets and infrastructure.

### SUMMARY

In one embodiment, a double hinge assembly is described including a center wing having a first center wing barrel portion and a second center wing barrel portion, a barrel pin, and a swing panel including a swing panel barrel portion, where the swing panel barrel portion and the second center wing barrel portion are adjoined by the barrel pin to form a first pivot about a first axis. Further aspects of the double hinge assembly include the first and second center wing barrel portions being formed respectively at two opposing edges of the center wing, the center wing including a tab at one end, and the tab projecting perpendicularly outward with respect to major sides of the center wing. The swing panel may also include a plurality of mounting through holes and at least one wire harness through hole.

Among embodiments, the first center wing barrel portion includes a first number of barrel sections and the second center wing barrel portion includes a second number of barrel sections greater than the first number, where the first center wing barrel portion is positioned along one edge of the center wing based on positions of cabinet barrel pins of an existing cabinet.

The second center wing barrel portion may be adjoined to an existing cabinet by a cabinet barrel pin to form a second pivot about a second axis. When adjoined to an existing cabinet, a major surface of the center wing and an exterior surface of the cabinet may substantially occupy a same first plane at a closed position of the double hinge assembly, and a major surface of the swing panel occupies a plane other than the first plane. Further, an exterior surface of the cabinet and a first edge of the tab may be in contact at an open position of the double hinge assembly, and an exterior surface of the control enclosure and a second edge of the tab opposite the first edge may also be in contact.

In another embodiment, a double hinge enclosure assembly is described including a cabinet having at least one cabinet barrel pin, a control enclosure including control circuitry, a center wing including first and second center wing barrel portions, a barrel pin, and a swing panel including a swing panel barrel portion, where the swing panel barrel portion and the second center wing barrel portion are adjoined by the barrel pin to form a first pivot about a first axis and the at least one cabinet barrel pin and the first center wing barrel portion and adjoined to form a second pivot about a second axis. Further aspects of the double hinge enclosure assembly include the first and second center wing barrel portions being formed respectively at two opposing edges of the center wing, the center wing including a tab at one end, and the tab projecting perpendicularly outward with respect to major sides of the center wing.

### BRIEF DESCRIPTION OF THE DRAWINGS

For a more complete understanding of the embodiments described herein and the advantages thereof, reference is now made to the following description in conjunction with the accompanying figures briefly described as follows:

FIG. 1A illustrates a side view of a double hinge assembly;

FIG. 1B illustrates a top view of a double hinge assembly;

FIG. 1C illustrates a top perspective view of a double hinge assembly;

FIG. 2A illustrates a side view of a center wing of a double hinge assembly;

FIG. 2B illustrates a swing panel of a double hinge assembly;

FIG. 3 illustrates a control cabinet, a control enclosure, and a double hinge assembly;

FIG. 4 illustrates a top view of a control cabinet, a control enclosure, and a double hinge assembly in a closed position;

FIG. 5 illustrates a top view of a control cabinet, a control enclosure, and a double hinge assembly in a second position;

FIG. 6 illustrates a top view of a double hinge assembly in a first position;

FIG. 7 illustrates a top view of a double hinge assembly in a second position;

FIG. 8 illustrates a top view of a control cabinet, a control enclosure, and a double hinge assembly in a third position;

FIG. 9 illustrates a top view of a control cabinet, a control enclosure, and a double hinge assembly in a fourth position;

FIG. 10 illustrates a top view of a double hinge assembly in a third position; and

FIG. 11 illustrates a top view of a double hinge assembly in a fourth position.

### DETAILED DESCRIPTION

A double hinge assembly described herein permits a control enclosure including updated controls and associated circuitry to be mounted within an existing control cabinet while permitting the updated control enclosure to have sufficient clearance to swing out from within the existing control cabinet for servicing, without any part of the updated control enclosure making contact with the existing control cabinet. According to aspects of the double hinge assembly described herein, the updated control enclosure is permitted to occupy a substantial area of the enclosed space within the existing control cabinet, while still permitting the updated control enclosure to be easily serviceable by a field technician. Further, the double hinge assembly described herein provides a field technician with flexibility for installation of updated control enclosures into existing control cabinets manufactured by various manufacturers. In this context, the double hinge assembly described herein saves cost because existing control cabinets and other infrastructure can be reused when updating control enclosures.

According to aspects of the double hinge assembly described herein, a double hinge assembly including a center wing having first and second barrel portions, and a swing panel including a barrel portion is described. When installed into an existing control cabinet along with an updated control enclosure, the double hinge assembly permits the updated control enclosure to pivot about first and second pivot points among predetermined positions and angles, such that a rear corner of the updated control enclosure clears all features (i.e., structures) of the existing control cabinet when the updated control enclosure is swung out from within the existing control cabinet.

In certain embodiments, the double hinge assembly described herein is formed to have a limited range of motion about first and second pivots of the double hinge assembly. As described with reference to the example embodiments below, the double hinge assembly permits an updated control enclosure to swing among a plurality of predetermined positions about each of first and second pivot points. While the double hinge assembly is generally described in association with retrofitting existing control cabinets with updated control systems, the double hinge assembly is not limited to such applications. Rather, the double hinge assembly may be used in other applications identified by one having ordinary skill in the art.

Turning to the figures, in which like numerals indicate like elements throughout, various embodiments, features, and aspects are described in detail.

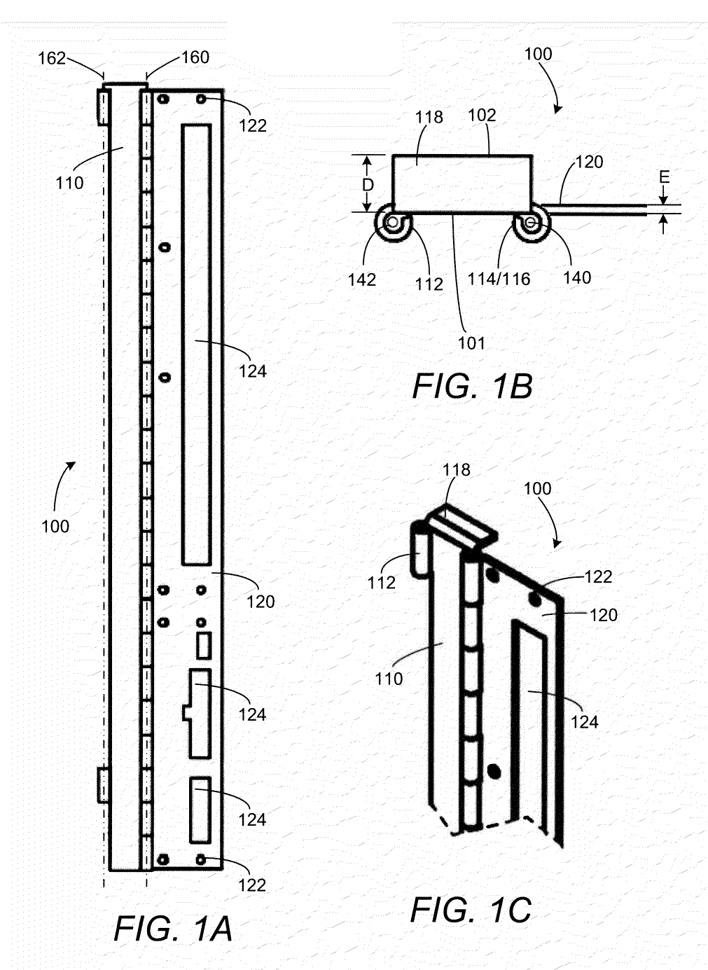

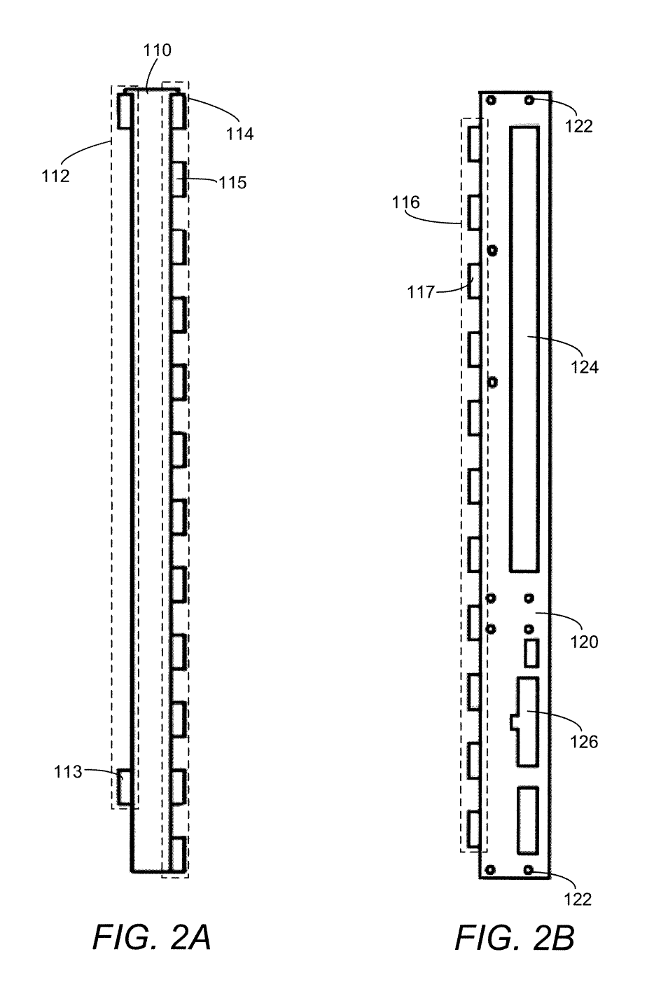

FIG. 1A illustrates a side view of a double hinge assembly 100 according to one example embodiment. The double hinge assembly 100 includes a center wing 110 and a swing panel 120. As illustrated in FIG. 1A, the swing panel 120 includes a plurality of mounting through holes 122 and at least one wire harness through hole 124. It is noted that the number and positions of the holes 122 and 124 may vary among embodiments of the double hinge assembly 100. Turning to FIG. 2A, the center wing 110 includes a first center wing barrel portion 112 and a second center wing barrel portion 114. With reference to FIG. 2B, the swing panel 120 includes a swing panel barrel portion 116. Each of the barrel portions includes an eye through which a barrel pin may be inserted to adjoin with another barrel portion to create a pivot at a respective axis, as described in further detail below.

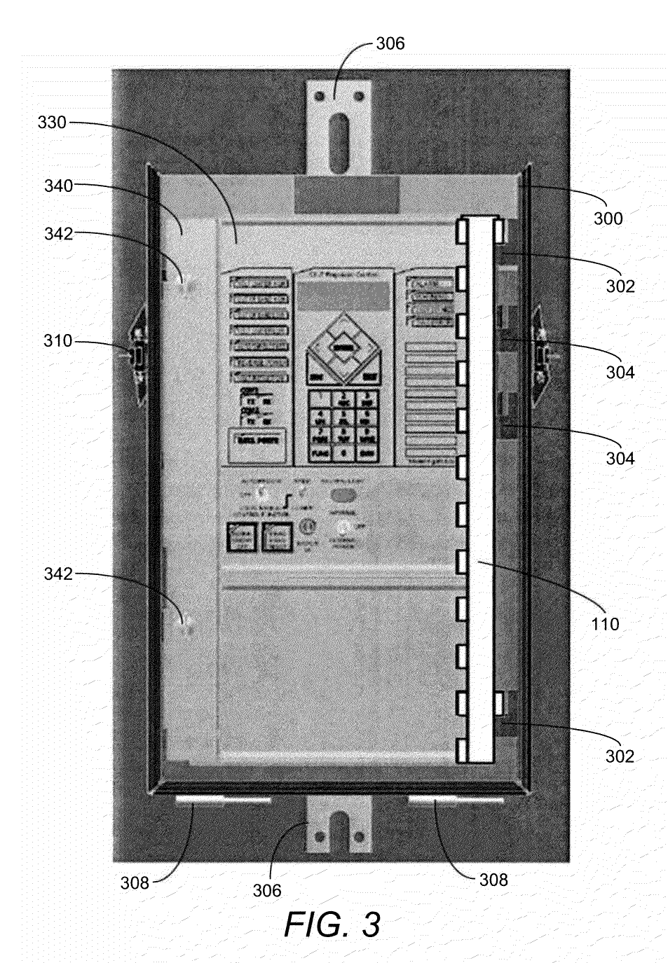

Turning to FIG. 1B, a top view of the double hinge assembly 100 is illustrated. In FIG. 1B, the first center wing barrel portion 112 is illustrated, and the second center wing and swing panel barrel portions 114/116 are illustrated in an adjoined position. That is, the second center wing and swing panel barrel portions 114/116 are adjoined by the pin 140 to form a first pivot at a first axis 160 (see FIG. 1A). FIG. 1B also illustrates a tab 118 that projects from an end of the center wing 110. As seen in FIG. 1B, a dimension D between first 101 and second 102 opposing edges of the tab 118 is larger than a dimension E between the two largest faces of the swing panel 120. The dimension D of the tab 118 is herein referred to as the “width” of the tab 118. It is noted that, although the tab 118 is illustrated as projecting from a top end of the center wing 110, the tab 118 may alternatively project from a bottom end of the center wing 110 or from both the top and bottom ends of the center wing. FIG. 1B further illustrates a second barrel pin 142 that fauns a second pivot at a second axis 162 (see FIG. 1A). It is noted that the double hinge assembly 100 does not include the second barrel pin 142. Instead, the second barrel pin 142 is a barrel pin of a cabinet, as discussed in further detail below with reference to FIG. 3.

FIG. 1C illustrates a top perspective view of the double hinge assembly 100. In FIG. 1C, the projection of the tab 118 from the top end of the center wing 110 is more clearly illustrated. The tab 118 is formed to extend perpendicularly outward with respect to the major sides of the center wing 110. As described in more detail below, the tab 118 may be used by a field technician to initiate movement of the double hinge assembly by pulling the center wing 110 of the double hinge assembly 100. In that context, the width or dimension D of the tab 118 may be selected such that a surface area of the tab 118 is sufficient for the field technician to grab with his fingers.

As illustrated among FIGS. 1 and 2, the first 112 and second 114 center wing barrel portions are formed respectively at two opposing edges of the center wing. The dimension D of the tab 118 illustrated in FIG. 1B is defined as a distance between the two opposing edges 101 and 102 of the tab 118. Further, the dimension E of the swing panel 120 illustrated in FIG. 1B is defined as the distance between the two largest faces of the swing panel 120.

As illustrated in FIG. 2, both the first and second center wing barrel portions 112 and 114 comprise a plurality of barrel sections. As an example, the first center wing barrel portion 112 comprises two barrel sections 113 and the second center wing barrel portion comprises twelve barrel sections 115. The swing panel barrel portion 116 also comprises a plurality of barrel sections 117. It is noted that the number of barrel sections 113, 115, and 117 may vary among embodiments and applications of the double hinge assembly 100. In other words, based on a size of the double hinge assembly 100 and an amount of weight the double hinge assembly 100 is designed to support, the double hinge assembly 100 may include additional or fewer barrel sections 113, 115, and 117. According to the illustrated embodiment, the second center wing barrel portion 114 includes more barrel sections than the first center wing barrel portion 112.

The mounting through holes 122 of the swing panel 120 permit the swing panel 120 to be mounted to an enclosure, such as an updated control enclosure, as described in further detail with reference to FIG. 3 below. The at least one wire harness through hole 124 permits a wire harness to pass through the swing panel 120 and make an electrical connection to circuitry enclosed within an updated control enclosure. In certain embodiments, the swing panel 120 may omit the at least one wire harness through hole 124. Additional aspects and features of the double hinge assembly 100 are described in further detail below with reference to FIGS. 3-11.

Turning to FIG. 3, the double hinge assembly 100 is illustrated in conjunction with a control cabinet 300 and a control enclosure 330. FIG. 3 illustrates a front view of the cabinet 300 and the control enclosure 330 which is supported within the cabinet 300 by the double hinge assembly 100. The double hinge assembly 100 supports the control enclosure 330 and attaches the control enclosure 330 to the cabinet 300, while permitting the control enclosure 330 to swing out from within the cabinet 300 for service, maintenance, and easy installation. The control cabinet 300 may comprise an existing or legacy control cabinet previously installed along with control systems and other infrastructure. As described above, reuse of the existing control cabinet 300 when updating control systems such as those enclosed within the control enclosure 330 saves time and costs.

The cabinet 300 includes cabinet barrel pins 302 and 304, mounting plates 306, door pins 308, and door locks 310. The cabinet barrel pins 302 and 304 are formed at positions along one side of the cabinet 300 based on the original design of the cabinet 300. In connection with the double hinge assembly 100 described herein, the pins 302 and 304 of the cabinet 300 may be taken into consideration in the design of the double hinge assembly 100. The double hinge assembly 100 may be formed to adjoin the pins 302 or 304 for supporting the control enclosure 330 while permitting the control enclosure 330 to swing out from within the control cabinet 300. As illustrated in FIG. 3, the center wing 110 may be adjoined to the cabinet barrel pins 302 of the cabinet 300 at the first center wing barrel portion 112. In that sense, the cabinet barrel pins 302 are the same as the pin 142 illustrated in FIG. 1B, and adjoin the center wing 110 to the cabinet 300 and form a second pivot at the second axis 162 of the double hinge assembly 100.

The control enclosure 330 encloses various circuitry and other controls associated with control systems of a power distribution system, for example. Thus, a face of the control enclosure 330 includes various displays, buttons, switches, and indicators as illustrated in FIG. 3. At one side of the control enclosure 330, a plate 340 is provided which includes securing fasteners 342. The securing fasteners 342 secure the control enclosure 330 in a closed position within the cabinet 300. A cabinet door (not shown) may additionally be attached to the door pins 308 and be locked by the lock 310 to enclose the control enclosure 330 within the cabinet 300. In this manner, the cabinet 300 may be completely or partially sealed from the environment to protect the circuitry and other controls within the control enclosure 330.

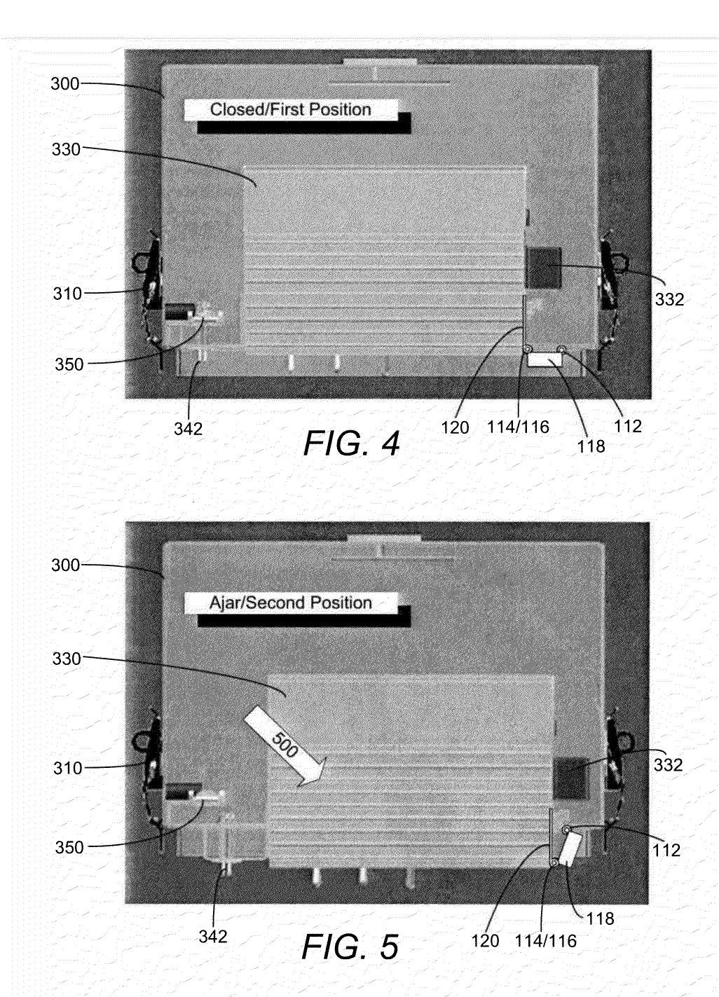

Turning to FIG. 4, a top-down view of the cabinet 300 and the control enclosure 330 is illustrated. For ease of installation and maintenance, it may be preferable to mount the control enclosure 330 within the cabinet 300 using a hinge, so the control enclosure 330 may swing out from within the cabinet 300 for access while being supported by the hinge. However, mounting the control enclosure 330 to the cabinet 300 at one side of the control enclosure 330 using a conventional hinge presents a problem. Because the control enclosure 330 occupies a substantial volume of the enclosed area within the cabinet 300, it may not be possible to mount the control enclosure 330 within the cabinet 300 using a conventional hinge while also permitting the control enclosure 330 to swing out from within the cabinet 300. More specifically, when attempting to swing the control enclosure 330 based on a single pivot of a conventional hinge mounted between one side of the control enclosure 330 and the cabinet 300, a rear corner of the control cabinet 300 is likely to contact an interior surface or structure of the cabinet 300, preventing movement. According to aspects of the double hinge assembly 100 described herein, the double hinge assembly 100 provides a means to mount the control enclosure 330 within the cabinet 300 while also providing a solution to the problem described above with respect to a conventional hinge.

From the top-down view in FIG. 4, it is also noted that the control enclosure 330 may further include elements, such as wire harness 332, mounted about the periphery of its external surfaces. Thus, it may not be feasible to mount the control enclosure 330 at a right-justified position within the cabinet 330 in an attempt to permit clearance for the control enclosure 330 to swing out from within the cabinet 300 using a conventional hinge. That is, the wire harness 332 and other elements mounted about the periphery of the control enclosure 330 may require that the control enclosure 330 be mounted at an approximate center of the area enclosed by the cabinet 300. The double hinge assembly 100 was designed in view of the above considerations.

Referring again to FIG. 4, the control enclosure 330 is mounted to the swing panel 120 of the double hinge assembly 100 at one side of the control enclosure 330 by screws or other suitable fasteners using the mounting through holes 122 of the swing panel 120. In alternative embodiments, the swing panel 120 may be mounted to other sides of the control enclosure 330 including the front of the control enclosure 330. In a closed or first position illustrated in FIG. 4, the entire control enclosure 330 is within the cabinet 300, and the fastener 342 locks the control enclosure 330 at a fixed position in conjunction with a fastening receptacle 350 of the cabinet 300.

When a field technician installs the control enclosure 330 within the cabinet 300 or performs maintenance on circuitry enclosed within the control enclosure 330, the double hinge assembly 100 permits the control enclosure 330 to swing out from within the cabinet 300 without any contact between the cabinet 300 or the locking receptacle 350. Even if contact between the control enclosure 330 and the cabinet 300 does occur in association with swinging the control enclosure 330 out from within the cabinet 300, the first and second pivots of the double hinge assembly 100 ensure that the contact does not completely prevent the control enclosure 330 from being withdrawn from the cabinet 300, as described below. The double hinge assembly 100 also fully supports the control enclosure 330 throughout the positions described in further detail below.

In FIG. 5, an ajar or second position of the double hinge assembly 100 is illustrated. As shown, the fasteners 342 are opened and the control enclosure 330 is shifted to the right and out from within the cabinet 300. The opening and shifting may be performed by a field technician using the tab 118, for example. In the ajar or second position, the double hinge assembly 100 has pivoted about the first and second axes 160 and 162 as compared to the first position illustrated in FIG. 4. According to movement about the first and second pivots at the first and second axes 160 and 162 of the double hinge assembly 100, the control enclosure 330 moves between the first and second positions in a substantially straight direction 500. In other words, between the first and second positions of the double hinge assembly, the control enclosure 330 has not rotated. In this manner, the control enclosure 330 is placed in a better position to be withdrawn from the cabinet 300 without contact.

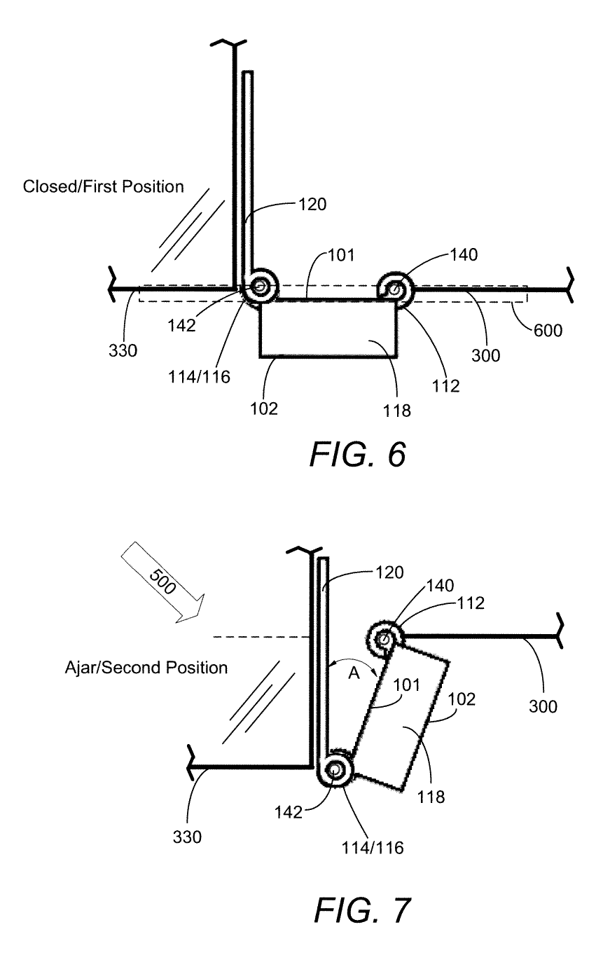

Turning to FIG. 6, a closer view of the double hinge assembly 100 at the closed or first position is illustrated. In the closed or first position, an exterior surface of the cabinet 300, a major surface of the center wing 110, and an exterior surface of the control enclosure 330 each substantially occupies a same plane 600. Additionally, at the closed or first position of the double hinge assembly 100, a major surface of the swing panel 120 occupies a plane other than the plane 600 occupied by the exterior surface of the cabinet 300, the major surface of the center wing 110, and the exterior surface of the control enclosure 330.

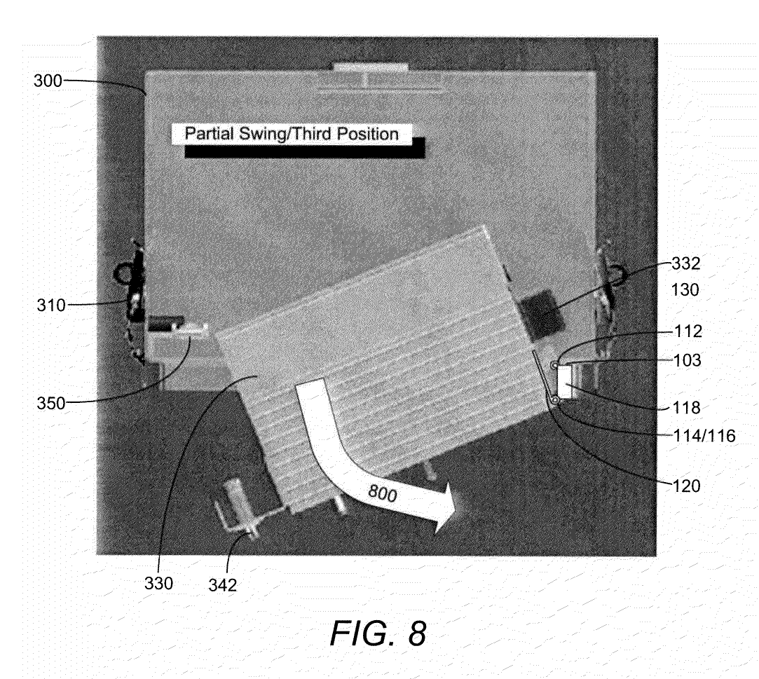

Turning to FIG. 7, a closer view of the double hinge assembly 100 at the ajar or second position is illustrated. At the second position, an angle A is formed between the swing panel 120 and the edge 101 of the tab 118. A value of the angle A may differ at the second position depending upon several factors such as the dimensions of one or more wire harnesses on the side of the control enclosure 300 secured to the swing panel 120. In other words, the value of the angle A may differ at the second position before the double hinge assembly 100 is moved into the next position describe below. Between the closed or first position and the ajar or second position, the control enclosure 330 has shifted in the direction 500 to the right and outward from within the cabinet 300. From the ajar or second position, the control enclosure 300 is at a better position to swing out from within the cabinet 300 without contacting any portion the cabinet 300. In other words, the double hinge assembly 100 may further pivot via the second pivot at the second axis 162, to swing the control enclosure 330 out from within the cabinet 300 as illustrated in FIG. 8.

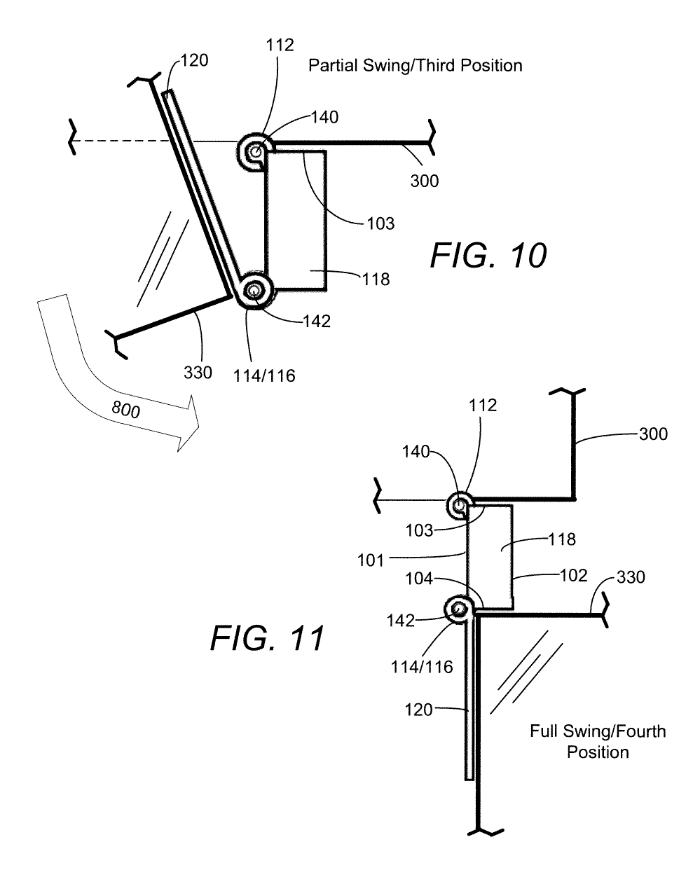

FIG. 8 illustrates a partial swing or third position of the double hinge assembly 100. From the ajar or second position, the double hinge assembly 100 may continue to swing about the second pivot at the second axis 162, moving the control enclosure 330 out from within the cabinet 300. The double hinge assembly 100 is formed to swing the control enclosure 330 about the second pivot at the axis 162 in a direction 800 until an edge 103 of the tab 118 contacts an exterior surface of the cabinet 300. This position is illustrated in FIGS. 8 and 10.

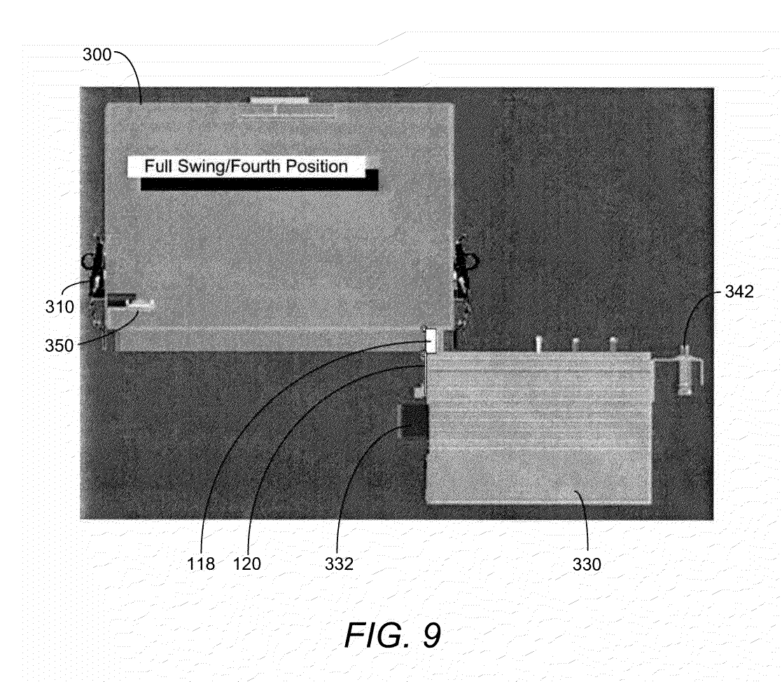

Turning to FIG. 9, once the edge 103 of the tab 118 contacts the exterior surface of the cabinet 300 as illustrated in FIGS. 8 and 10, the double hinge assembly 100 may be further pivoted again about the first axis 160 so that the control enclosure 330 continues to swing out from within the cabinet 300. In this context, FIG. 9 illustrates a full swing or fourth position of the double hinge assembly 100. At the position illustrated in FIG. 9, a field technician has complete access to the control enclosure 330 and the interior of the cabinet 300. It is further noted that the wiring harness 332 is fully accessible to the field technician at the full swing or fourth position. Also, the control enclosure 330 may be mounted to the cabinet 300 using the cabinet barrel pins 302 while the double hinge 100 is at the full swing or fourth position. Thus, during installation of the control enclosure 330, the double hinge assembly 100 may be adjoined to the cabinet barrel pins 302 while the control enclosure 330 is completely outside the cabinet 300. In this manner, retrofitting the existing cabinet 300 with the updated control enclosure 330 is relatively simple.

FIG. 10 illustrates a closer view of the double hinge assembly 100 at the partial swing or third position. As illustrated in FIG. 10, the double hinge assembly 100 has pivoted about the second pivot at the second axis 162 in the direction 800 from the ajar or second position to the third or partial swing position. At the third position, one edge 103 of the tab 118 contacts an exterior surface of the cabinet 300. From the third position, the double hinge assembly 100 may further pivot about the first pivot at the first axis 160 based on controlled movement of the control enclosure 330 by a field technician.

Turning to FIG. 11, a closer view of the double hinge assembly 100 at the full swing or fourth position is illustrated. In the full swing or fourth position, the edge 103 of the tab 118 contacts an exterior surface of the cabinet 300, and an edge 104 opposite the edge 103 of the tab 118 contacts an exterior front-facing surface of the control enclosure 330.

Among FIGS. 6, 7, 10, and 11, a complete range of motion of the double hinge assembly 100 is illustrated. Based on shifting the control enclosure 330 outward from the cabinet 300 and to the right in the direction 500, as illustrated in the second position of FIG. 7, the control enclosure 330 is positioned such that the rear corner of the control enclosure 330 is able to swing out from within the cabinet 300 without contacting the cabinet 300. Further, the edges 103 and 104 of the tab 118, in association with surfaces of the cabinet 300 and the control enclosure 330, partially determine ranges of motion of the first and second pivots of the double hinge assembly 100. When fully rotated to the third position, the edge 103 of the tab 118 contacts the exterior surface of the cabinet 300 and prevents further rotation of the double hinge assembly 100 about the second pivot at the second axis 162. Continuing to the full swing or fourth position, the double hinge assembly 100 may be pivoted again about the first pivot at the first axis 160 to further swing the control enclosure 330 to the full swing or fourth position illustrated in FIGS. 9 and 11. At the full swing position, the double hinge assembly 100 is no longer able to rotate in the direction 800, because the edges 103 and 104 of the tab 118 respectively contact an exterior surface of the cabinet 300 and exterior front-facing surface of the control enclosure 330, preventing further rotation in the direction 800.

Although embodiments of the present invention have been described herein in detail, the descriptions are by way of example. The features of the invention described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

1. A double hinge assembly, comprising:
a center wing including a first center wing barrel portion and a second center wing barrel portion;
a barrel pin; and
a swing panel including a swing panel barrel portion, wherein
the swing panel barrel portion and the second center wing barrel portion are adjoined by the barrel pin to form a first pivot about a first axis.

2. The double hinge assembly of claim 1, wherein
the second center wing barrel portion is adjoined to a cabinet by at least one cabinet barrel pin to form a second pivot about a second axis.

3. The double hinge assembly of claim 1, wherein
a control enclosure is mounted to the swing panel.

4. The double hinge assembly of claim 1, wherein the first and second center wing barrel portions are formed respectively at two opposing edges of the center wing.

5. The double hinge assembly of claim 1, wherein
the center wing includes a tab at one end of the center wing, the tab projecting perpendicularly outward with respect to major sides of the center wing;
a width of the tab is defined as a distance between two opposing edges of the tab,
a thickness of the swing panel is defined as a distance between two largest faces of the swing panel, and
the width of the tab is greater than the thickness of the swing panel.

6. The double hinge assembly of claim 1, wherein the first center wing barrel portion comprises a first number of barrel sections and the second center wing barrel portion comprises a second number of barrel sections greater than the first number.

7. The double hinge assembly of claim 6, wherein the first center wing barrel portion is positioned along one edge of the center wing based on positions of cabinet barrel pins of an existing cabinet.

8. The double hinge assembly of claim 2, wherein
at a closed position of the double hinge assembly, a major surface of the center wing and an exterior surface of the cabinet substantially occupy a same first plane, and
at the closed position of the double hinge assembly, a major surface of the swing panel occupies a plane other than the first plane.

9. The double hinge assembly of claim 5, wherein
the second center wing barrel portion is adjoined to a cabinet by a cabinet barrel pin to form a second pivot about a second axis,
a control enclosure is mounted to the swing panel,
at an open position of the double hinge assembly, an exterior surface of the cabinet and a first edge of the tab are in contact, and
at the open position of the double hinge assembly, an exterior surface of the control enclosure and a second edge of the tab opposite the first edge are in contact.

10. The double hinge assembly of claim 1, wherein
the swing panel includes a plurality of mounting through holes and at least one wire harness through hole.

11. A double hinge enclosure assembly, comprising:
a cabinet including at least one cabinet barrel pin;
a control enclosure including control circuitry;
a center wing including first and second center wing barrel portions;
a barrel pin; and
a swing panel including a swing panel barrel portion, wherein
the swing panel barrel portion and the second center wing barrel portion are adjoined by the barrel pin to form a first pivot about a first axis and the at least one cabinet barrel pin and the first center wing barrel portion and adjoined to form a second pivot about a second axis.

12. The double hinge enclosure assembly of claim 11, wherein the first and second center wing barrel portions are formed respectively at two opposing edges of the center wing.

13. The double hinge enclosure assembly of claim 11, wherein
the center wing includes a tab at one end of the center wing, the tab projecting perpendicularly outward with respect to major sides of the center wing;
a width of the tab is defined as a distance between two opposing edges of the tab,
a thickness of the swing panel is defined as a distance between two largest faces of the swing panel, and
the width of the tab is greater than the thickness of the swing panel.

14. The double hinge enclosure assembly of claim 11, wherein the first center wing barrel portion comprises a first number of barrel sections and the second center wing barrel portion comprises a second number of barrel sections greater than the first number.

15. The double hinge enclosure assembly of claim 11, wherein the first center wing barrel portion is positioned along one edge of the center wing based on a position of the at least one cabinet barrel pin.

16. The double hinge enclosure assembly of claim 11, wherein
at a closed position of the double hinge enclosure assembly, a major surface of the center wing and an exterior surface of the cabinet substantially occupy a same first plane, and
at the closed position of the double hinge enclosure assembly, a major surface of the swing panel occupies a plane other than the first plane.

17. The double hinge enclosure assembly of claim 13, wherein
at an open position of the double hinge enclosure assembly, an exterior surface of the cabinet and a first edge of the tab are in contact, and
at the open position of the double hinge enclosure assembly, an exterior surface of the control enclosure and a second edge of the tab opposite the first edge are in contact.

18. The double hinge assembly of claim 11, wherein
the swing panel includes a plurality of mounting through holes and at least one wire harness through hole.
